(19) United States
(12) Patent Application Publication
(10) Pub. No.: US 2020/0250212 A1
(43) Pub. Date: Aug. 6, 2020

(54) Methods and Systems for Searching, Reviewing and Organizing Data Using Hierarchical Agglomerative Clustering

(71) Applicant: Agnes Intelligence Inc., New York, NY (US)

(72) Inventors: John Macartney, Pottstown, PA (US); John H. Snyder, Brooklyn, NY (US); Matthew Grossman, New York, NY (US); Lucy Phillips, Brookyln, NY (US); Thomas C. Sima, White Plains, NY (US); Amy Snyder, Brooklyn, NY (US); Brian Matheson, Ulster Park, NY (US)

(21) Appl. No.: 16/267,675

(22) Filed: Feb. 5, 2019

(51) Int. Cl. G06F 16/332; G06F 17/28; G06F 16/11; G06F 16/338

(52) U.S. Cl. CPC G06F 16/3329; G06F 17/2845; G06F 16/338; G06F 16/3328; G06F 16/116

(57) ABSTRACT

In a method and system for reviewing, searching and analyzing raw data in a data corpus a corpus optimization module converts the raw data to an optimized corpus. A search composition module operates on the optimized corpus to derive a set of search parameters and a concept extraction module extracts a set of initial concept clusters using the set of search parameters. A hybrid review module receives the set of initial concept clusters from the concept extraction module and allows a user to review the optimized corpus using a user interface until the user declares the review complete. A visualization module visualizes the results of the review, search and analysis of the raw data in the data corpus after the user declares the review complete.

### TECHNICAL FIELD

The present invention generally relates to the field of computerized data analysis, and more particularly, to an improved method and system for efficiently and accurately searching and analyzing a large corpus of data.

### BACKGROUND OF THE INVENTION

The widespread use of computers and the accompanying technological advances have resulted in the routine generation, retention, and storage of large volumes of structured and unstructured electronic data by individuals and businesses. This electronic data may include, but is not limited to, written data or spoken-word data. Written data may include, but is not limited to, emails, text messages, social media content, presentations, cloud-based applications, and any other data contained in data repositories which include structured, unstructured or semi-structured text (in any language or file format). In contrast, spoken word data may include, but is not limited to, recorded phone calls, podcast content, audio files, video files and any other recordings of human speech (in any language or file format).

It is often desirable to quickly and efficiently review and analyze a large corpus of data comprised of written and/or spoken word data. For instance, in the context of legal disputes, the parties to a lawsuit often collect, index, review, and produce large volumes of electronic documents/files which the receiving party, in turn, must review for the purpose of identifying key documents that are of importance to the particular lawsuit. The same is true with respect to legal transactions (e.g., sale of a company) which often entail the review and analysis of large volumes of data in connection with the corporate due diligence process. Traditionally, attorneys must review each document and determine if the particular document is relevant to the issues at hand. The attorneys will then electronically “tag” each document with an appropriate relevancy designation (hot, warm, cold) and, commonly, with “issue tags” that associate the document with a particular pre-defined “issue.” Such prior art methods for the review and analysis of large volumes of data are both expensive and time consuming.

Typically, parties to a lawsuit expend significant time and money reviewing an extensive corpus of data to identify a relatively small number of key documents relevant to particular issues in dispute. Accordingly, the ever-expanding volume of data generated translates into ever-increasing costs associated with reviewing documents in legal disputes and transactions. Current efforts to control review costs have focused on limiting the size of the review corpus by, for example, limiting the number of custodians, time frames, search terms, etc. used to collect the data at the outset. However, this is a brute-force method that focuses on broad metadata and keyword filtering and fails to provide an efficient and effective approach to reviewing all the documents in a corpus and identifying the most important ones.

Similarly, it may be desirable to efficiently and accurately perform a free-form search and analysis of a given data corpus for purposes outside a legal platform. For instance, it may be desirable to analyze a corpus of data generated by a given group (e.g., a group of social media users) to identify the group's sentiment or preferences on one or more topics of interest.

Accordingly, it is desirable to develop an improved method and system for efficiently and effectively collecting, indexing, reviewing, searching, analyzing, and visualizing a large corpus of electronic data.

### SUMMARY

The present disclosure may comprise one or more of the following features and combinations thereof.

In accordance with a first illustrative embodiment the present disclosure is directed to a system for reviewing, searching and analyzing raw data in a data corpus. The system comprises a corpus optimization module which converts the raw data to an optimized corpus; a search composition module which operates on the optimized corpus to derive a set of search parameters; a concept extraction module which performs a search on the optimized corpus using the set of search parameters derived by the search composition module and extracts a set of initial concept clusters; a hybrid review module which receives the set of initial concept clusters from the concept extraction module and allows a user to review the optimized corpus using a user interface until the user declares the review complete; and a visualization module which visualizes the results of the review, search and analysis of the raw data in the data corpus after the user declares the review complete.

In accordance with a second illustrative embodiment the present disclosure is directed to a method of reviewing, searching and analyzing raw data in a data corpus. The method comprises converting the raw data to an optimized corpus in a corpus optimization module; deriving a set of search parameters in a search composition module, wherein the search parameters are derived by operating on the optimized corpus; performing a search on the optimized corpus using the set of search parameters derived by the search composition module and extracting a set of initial concept clusters in a concept extraction module; receiving the set of initial concept clusters from the concept extraction module in a hybrid review module and allowing a user to review the optimized corpus using a user interface until the user declares the review complete; and visualizing the results of the review, search and analysis of the raw data in the data corpus after the user declares the review complete in a visualization module.

In accordance with a third illustrative embodiment the present disclosure is directed to computer readable medium having program code recorded thereon for execution on an information handling system for reviewing, searching and analyzing a data corpus, the program code causing the information handling system to perform the following method steps: converting the raw data to an optimized corpus in a corpus optimization module; deriving a set of search parameters in a search composition module, wherein the search parameters are derived by operating on the optimized corpus; performing a search on the optimized corpus using the set of search parameters derived by the search composition module and extracting a set of initial concept clusters in a concept extraction module; receiving the set of initial concept clusters from the concept extraction module in a hybrid review module and allowing a user to review the optimized corpus using a user interface until the user declares the review complete; and visualizing the results of the review, search and analysis of the raw data in the data corpus after the user declares the review complete in a visualization module.

The objects, advantages and other features of the present invention will become more apparent upon reading of the following non-restrictive description of a preferred embodiment thereof, given by way of example only with reference to the accompanying drawings. Although various features are disclosed in relation to specific exemplary embodiments of the invention, it is understood that the various features may be combined with each other, or used alone, with any of the various exemplary embodiments of the invention without departing from the scope of the invention.

### BRIEF DESCRIPTION OF THE DRAWINGS

For a more complete understanding of the present invention and its features and advantages, reference is now made to the following description, taken in conjunction with the accompanying drawings, in which:

FIG. 1 depicts the modules of a core technology for collecting, indexing reviewing, searching, categorizing, analyzing, and visualizing a data corpus in accordance with an illustrative embodiment of the present disclosure.

FIG. 1a is an illustrative example of six separate document clusters (a-f) and represented in a 2D space.

FIG. 1b depicts the relationships between the clusters identified in FIG. 1a in a dendrogram.

FIG. 1c depicts an illustrative hierarchy of clustered documents with the cluster labels and number of documents in each cluster (shown in the circle next to each cluster label).

FIG. 2 is an illustrative graph showing the number of documents in the data corpus in prior reviews performed using the review platform and a corresponding number of “Hot” documents identified in each review in accordance with an exemplary embodiment of the present invention.

FIG. 3 is an illustrative graph showing the number of documents identified as “Hot” after reviewing 100 documents in the data corpus in prior reviews performed using the review platform and the corresponding total number of “Hot” documents identified in each review in accordance with an exemplary embodiment of the present invention.

FIG. 4 is an illustrative graph showing different estimates of the total cumulative number of “Hot” documents vs. the total number of documents reviewed based on the past reviews on the review platform for a data corpus containing a range of between 100,000 and 1 million documents in accordance with an exemplary embodiment of the present invention.

FIG. 5 is a conceptual review curve showing the contrast between a review implementing the Snyder Score in accordance with an embodiment of the present disclosure and a traditional document review process in accordance with the prior art.

FIG. 6 depicts a Dynamic Relevancy Display subsystem in accordance with an illustrative embodiment of the present disclosure.

FIGS. 7 and 8 depict an illustrative example of the visualized output provided on the user interface of an information handling system by the DRD subsystem 614 in accordance with an illustrative embodiment of the present disclosure.

FIG. 9 depicts a Public Sentiment Engine in accordance with an illustrative embodiment of the present disclosure.

While embodiments of this disclosure have been depicted and described and are defined by reference to example embodiments of the disclosure, such references do not imply a limitation on the disclosure, and no such limitation is to be inferred. The subject matter disclosed is capable of considerable modification, alteration, and equivalents in form and function, as will occur to those skilled in the pertinent art and having the benefit of this disclosure. The depicted and described embodiments of this disclosure are illustrative examples only, and not exhaustive of the scope of the disclosure,

### DESCRIPTION OF ILLUSTRATIVE EMBODIMENT(S)

The following detailed description illustrates embodiments of the present disclosure. These embodiments are described in sufficient detail to enable a person of ordinary skill in the art to practice these embodiments without undue experimentation. It should be understood, however, that the embodiments and examples described herein are given by way of illustration only, and not by way of limitation. Various substitutions, modifications, additions, and rearrangements may be made that remain potential applications of the disclosed techniques. Therefore, the description that follows is not to be taken as limiting on the scope of the appended claims. In particular, an element associated with a particular embodiment should not be limited to association with that particular embodiment but should be assumed to be capable of association with any embodiment discussed herein.

For the purposes of this disclosure, an information handling system may include an instrumentality or aggregate of instrumentalities operable to compute, classify, process, transmit, receive, retrieve, originate, switch, store, display, manifest, detect, record, reproduce, handle, or utilize various forms of information, intelligence, or data for business, scientific, control, entertainment, or other purposes. For example, an information handling system may be a server, a personal computer, a laptop computer, a smartphone, a PDA, a consumer electronic device, a network storage device, or another suitable device and may vary in size, shape, performance, functionality, and price. The information handling system may include memory, one or more processing resources such as a processor (e.g., a central processing unit (CPU) or hardware or software control logic). Additional components of the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

For the purposes of this disclosure, computer-readable media may include an instrumentality or aggregation of instrumentalities that may retain data and/or instructions for a period of time. Computer-readable media may include, without limitation, storage media such as a direct access storage device (e.g., a hard disk drive or floppy disk), a cloud server, a sequential access storage device (e.g., a tape disk drive), compact disk, CD-ROM, DVD, random access memory (RAM), read-only memory (ROM), electrically erasable programmable read-only memory (EEPROM), and/or flash memory (SSD); as well as communications media such as wires, optical fibers, microwaves, radio waves, and other electromagnetic and/or optical carriers; and/or any combination of the foregoing.

For the purposes of this disclosure, the term “data” includes all electronic data including any files (e.g., audio file, video files, text files, etc.), emails, text messages and documents that have been electronically stored to a computer readable media. Moreover, in the context of reviewing, searching and analyzing a corpus of data as described herein, the terms “document” and “file” may be used interchangeably as documents are saved in electronic form and are typically stored as a file in computer-readable media.

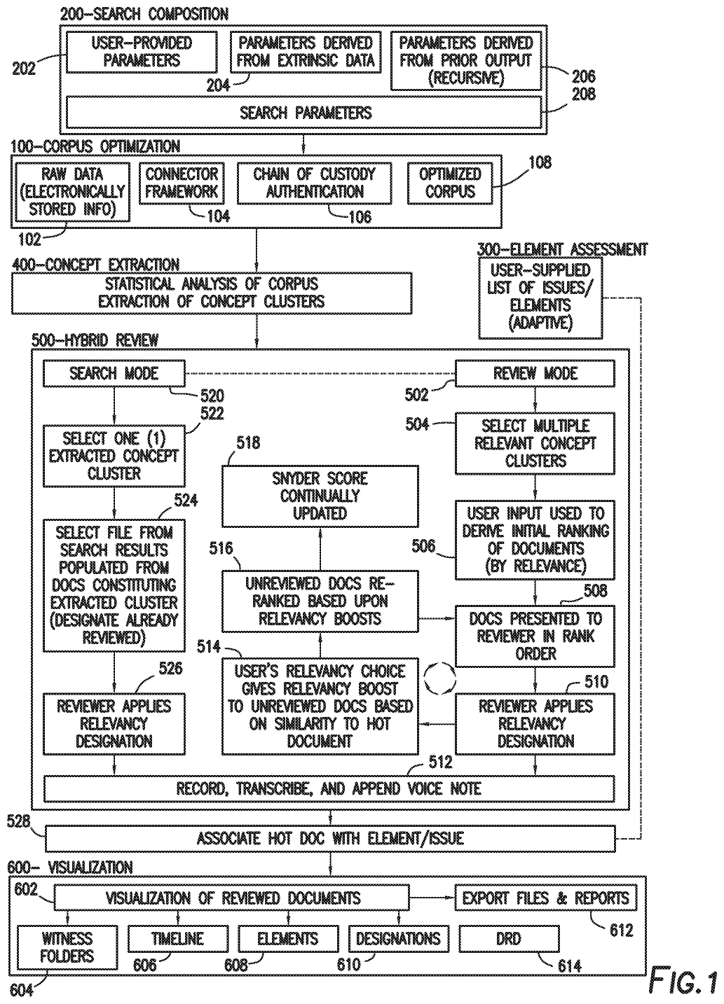

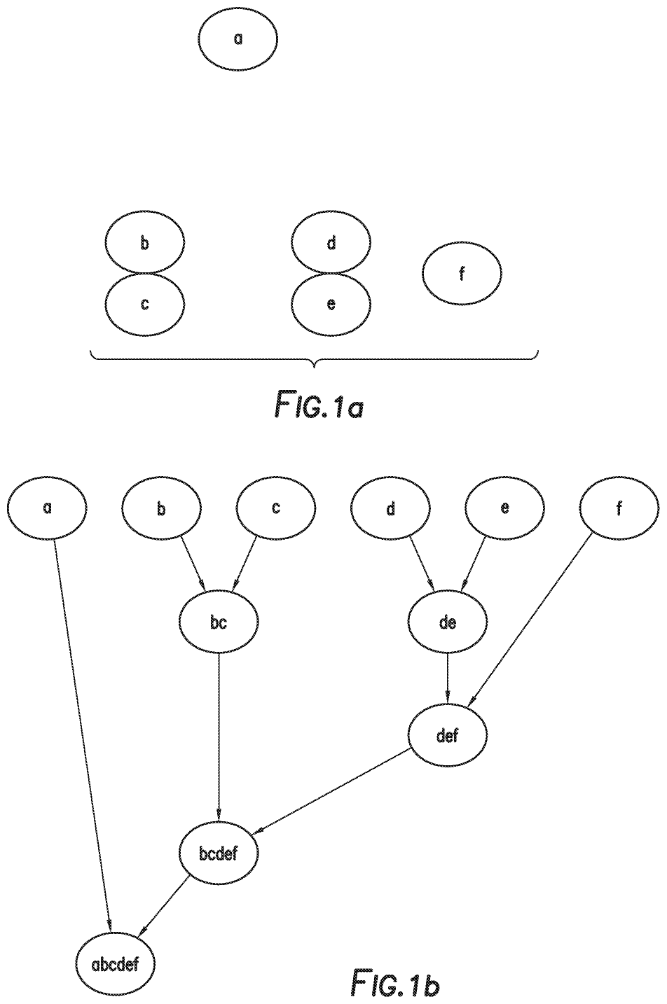

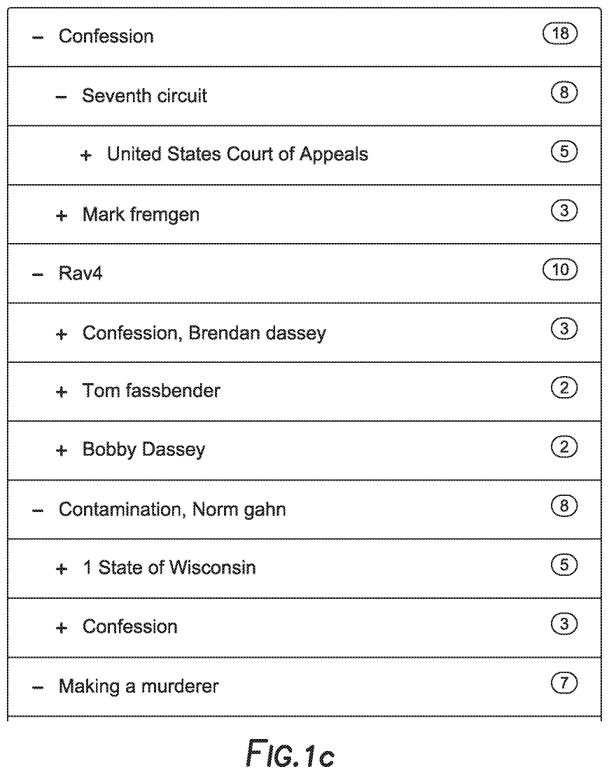

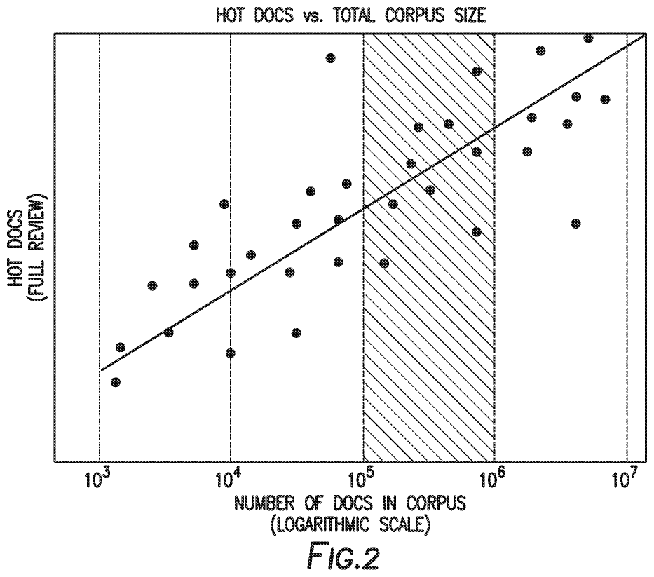

FIG. 1 depicts modules of a core technology for reviewing, searching, and analyzing a data corpus in accordance with an illustrative embodiment of the present disclosure. As would be appreciated by those of ordinary skill in the art, having the benefit of the present technology, the core technology may be implemented using an information handling system. In certain illustrative embodiments, a user may interface with the information handling system using a monitor, keyboard, and/or mouse to view and manipulate information. However, the term “user interface” is not limited to these specific components and other means to interface with the information handling system may be used without departing from the scope of the present disclosure. For example, in certain illustrative embodiments, the user may interface with the information handling system using voice commands. Moreover, in certain illustrative embodiments, the user may interface with the information handling system using an immersive “pod” including a headset, microphone and a joystick like controller. Additionally, in certain illustrative embodiments, the information handling system may be a mobile device and a user may interface with the information handling system by simply swiping left, right, up and/or down to submit instructions thereto. When implementing the methods and systems disclosed herein using an information handling system, a program code may be recorded on a computer readable medium for execution by the information handling system. Specifically, the execution of the computer program may cause the information handling system to perform the processes disclosed herein. Accordingly, the methods and systems disclosed herein may be implemented by a computer program (e.g., a software) running on an information handling system.

The disclosed core technology provides a novel method and system for searching, reviewing, and/or analyzing a large data corpus which may be comprised of written and/or spoken word data. The core technology may be utilized in conjunction with any application where it is desirable to search, review and/or analyze a large data corpus such as, for example, in conjunction with a legal platform or a media platform. The illustrative embodiment of FIG. 1 will now be discussed in conjunction with a review platform used for reviewing documents (e.g., in the context of a lawsuit or a transaction) on a legal platform. However, as would be appreciated by those of ordinary skill in the art, having the benefit of this disclosure, the present disclosure is not limited to this particular implementation and the method and systems disclosed herein can likewise be used in other instances where it is desirable to search, review or analyze a corpus of data.

More specifically, the core technology comprises of six modules including the corpus optimization module 100, the search composition module 200, the element assessment module 300, the concept extraction module 400, the hybrid review module 500 and the visualization module 600. These modules work in concert to facilitate the effective and accurate review, search and analysis of a large data corpus. The structure and operation of each of these modules is now discussed in further detail in conjunction with FIG. 1.

The data corpus to be reviewed, searched and analyzed is referred to as the “raw data” herein and is first loaded to a computer-readable media such as, for example, a cloud server. In the illustrative example of FIG. 1, the raw data 102 which may be comprised of a plurality of files is loaded on to a cloud server. The corpus optimization module 100 converts this raw data to an optimized corpus 108. Specifically, the raw data 102 is ingested and processed by a connector framework 104. The connector framework 104 stabilizes and standardizes the data in preparation for advanced data operations. To that end, the connector framework 104 aggregates the raw data 102 from its native format (e.g., PDFs, Microsoft Office documents, audio files, video files, content management systems, G-Suite files, etc.) and handles authentication in order to control access to the raw data 102.

In accordance with an illustrative embodiment of the present disclosure, the connector framework 104 maintains authentication and controls access to the raw data 102 by requiring each user to provide supplied credentials (e.g., a user name and a password) in order to be able to access the raw data 102. In accordance with certain illustrative embodiments, the access control provided by the connector framework 104 to the raw data 102 allows each user to only access a subset of the raw data 102 that is associated with the user's associated access group based on a pre-defined access control list. For instance, if a user is a member of a particular group (e.g., marketing team), the user may only be given access to the documents relating to that group (e.g., marketing documents) but not to the documents associated with other groups (e.g., executive team documents). Optionally, the connector framework 104 may allow a user belonging to particular group (e.g., executive team) to share a document from that group (e.g., an executive team document) with a member of another group (e.g., a marketing team member).

The connector framework 104 also reads the original source format and converts each file in the raw data 102 into unstructured text. In certain illustrative embodiments, the connector framework 104 integrates a third-party speech-to-text Application Programming Interface (“API”) to convert any audio from audio files or video files in the raw data 102 to unstructured text. The connector framework may be a software that runs on an information handling system.

In addition to converting the files in the raw data 102 to unstructured text, the connector framework 104 may extract additional information from each file in the raw data. For instance, in certain embodiments, the connector framework 104 may extract additional information inherent in the data and associate this extracted information with the corresponding piece of raw data. Specifically, the connector framework 104 may extract the additional information by performing one or more of natural language processing, voice fingerprinting, sentiment analysis, personality extraction, and persuasion metrics analysis on the raw data. This extracted information may then be used as metadata for further analysis and refinement.

The term “natural language processing” as used herein refers to a process that tries to convert unstructured human language into a structure that an information handling system can understand. For instance, if a user types the sentence “How tall is the empire state building?” into a search engine that supports natural language processing, the search engine will recognize that the subject of this query is the “empire state building” and the search engine is looking for a “fact” related to the height of the subject and the fact is represented as a number of measurement. The term “voice fingerprinting” as used herein refers to a process that takes advantage of the fact that every human voice is unique and that therefore, a voice can be converted into a digital signature. This digital signature (i.e., voice fingerprint) can then be used to match unique voices from future samples of audio to identify the person speaking in a manner similar to how a fingerprint is used to identify individuals. Further, in certain implementation where there are multiple speakers involved, diarization may be used to identify multiple speakers in an audio conversation. Specifically, diarization refers to the process of partitioning an audio stream having audio from multiple speakers into homogenous segments associated with each individual speaker. Accordingly, in instances with multiple speakers, diarizatoin may be used to determine “who spoke when.” The details of the diarization process are known to those of ordinary skill in the art having the benefit of the present disclosure and will therefore, not be discussed in detail herein.

The term “sentiment analysis” as used herein refers to a process for analyzing unstructured text and identifying opinions on a given topic as positive, negative, or neutral. The term “personality extraction” as used herein refers to a process for analyzing unstructured text samples from the same author and identifying some personality traits of the author. For example, personality extraction can process a sample of emails to determine personal traits of the author which could include degrees of aggression, openness, agreeability, introversion, etc. Finally, the term “persuasion metrics” as used herein refers to a process that has the ability to affect a user's decision-making process, these metrics would be gathered from the process to determine the effectiveness or level of persuasion.

In certain illustrative embodiments, the corpus optimization module 100 may further include a chain of custody authentication module 106. The chain of custody authentication module 106 keeps track of any changes to the files/documents comprising the raw data including, for example, which user accessed each file/document, whether any changes were made to each file/document, what changes were made to each file/document, and which user made each change. In accordance with certain illustrative embodiments, the chain of custody authentication module 106 may utilize blockchain technology in instances where it is desirable to provide chain of custody authentication. Specifically, once each file from the raw data 102 is ingested by the connector framework 104, the chain of custody authentication module 106 operates as a blockchain tagging unit and associates the file with an edit log maintained on a distributed ledger. Blockchain technology provides a level of verifiable trust which is currently widely implemented in the context of currency systems (e.g., Bitcoin, Etherium, etc.). The use of blockchain technology provides the unique quality of immutability, which means once a transaction occurs, it is recorded in a distributed ledger and it cannot be changed. This feature makes block chain technology particularly suitable for providing chain of custody authentication in the context of document management. Specifically, any changes to documents are represented as a chain in a distributed ledger by the blockchain tagging unit 106 and each document update is a new link on that chain. Accordingly, changes to the document chain are represented on the distributed transaction ledger by the chain of custody authentication module 106 in a way that all parties or users of the document management system can view. In this manner, the chain of custody authentication module 106 can provide chain of custody for document management. Optionally, the corpus optimization module 100 also de-dupes the raw data eliminating instances where the same document appears more than once in the corpus. Following these operations, the corpus optimization module 100 generates an optimized corpus 108 from the raw data 102.

The search composition module 200 operates on the optimized corpus 108 generated by the corpus optimization module 100. The objective of the search composition module 200 is to derive a set of search parameters that, when used by a Hierarchical Agglomerative Clustering (“IAC”) algorithm, will extract concept clusters from the optimized corpus 108 that are useful for further operations. The term “search parameter” as used herein includes, for example, keywords, sender name, recipient name, key players, key issues, or key dates. The nature of the search parameter will depend on the characteristics of the data being analyzed as well as the question that is being asked. As technology evolves and new data formats are introduced, the search parameters will inevitably evolve and become more refined. With the advent of wearable technology and “internet of things” sensor networks (as an example), the variety, volume, and granularity of collected data will greatly increase, leading to a need for more evolved strategies for extracting relevant information. The search parameters derived by the search composition module may then be used in the initial search of the optimized corpus 108. In accordance with an illustrative embodiment of the present disclosure, the search parameters may be derived in three ways, depending on the requirements of the particular implementation and/or user preferences.

In accordance with a first implementation 202, the user may provide the initial search parameters to be used by the search composition module 200. Specifically, the user may manually populate the search parameters through a user interface provided on an information handling system. For instance, the user may input the desired search parameters through an open input process without machine guidance using a microphone or using blank and unrestricted search boxes that are populated by text using a user interface. Specifically, the user may independently identify and input the desired search parameters. Alternatively, the metadata extracted from the optimized corpus 108 by the corpus optimization module 100 may be analyzed and the likely search terms may be provided to the user in a drop-down menu based on that analysis allowing the user to select the search terms from the menu. For example, if the search term is the sender name, the user may be permitted to simply input the sender name using a microphone or search boxes. Alternatively, the sender names extracted from the optimized corpus 108 metadata may be provided as options to the user in a drop-down menu allowing the user to make a selection.

In accordance with a second implementation 204, the search parameters for the initial search can be derived algorithmically from the contents of specified target files. In this embodiment, a user may provide said target files which may be text files or audio files that include, for example, the key witnesses, key dates, or key elements of the issues of interest, etc. The target files may be loaded onto a computer-readable media (such as, for example, a cloud server) and made available for access by the core technology. The initial search parameters may then be identified by the search composition module 200 based on statistically significant terms extracted from the target files uploaded and made available to the core technology for this specific purpose.

There are multiple options for performing concept extraction operations and identifying statistically significant terms. The option to be utilized is determined depending on the structure, if any, of the data set provided to the search composition module 200. For instance, email is an example of a target file which is structured. Email has some natural structure and associated metadata. Specifically, emails have metadata for subjects, recipient names and addresses, originator names and addresses, dates, etc. Accordingly, if the target file is structured data (e.g., an email), the concept extraction operation may entail identifying the associated metadata or utilizing the known structure of the target file. For example, in case of an email, the concept extraction operations may result in the extraction of data regarding email addresses, email subject lines, and/or names of senders or recipients of emails. Following the concept extraction operations, the statistically significant terms may be identified as the most frequently used email addresses, email subject lines, and/or names of senders or recipients.

In contrast, where the target file is unstructured data there may be limited or no metadata fields. With respect to such target files, the concept extraction operation performed by the search composition module 200 uses natural language understanding techniques to extract the concepts and to identify statistically significant terms. For example, in certain implementations, the search composition module 200 may utilize entity extraction to extract the names of people, places, organizations, etc. in the target files. In accordance with an illustrative embodiment, the search composition module 200 may be provided with a training set of all possible entities or entity patterns that it is likely to encounter. The system may then run the entity extraction from the target files provided to the search composition module 200 against this training set in order to extract the relevant concepts from each target file. The extracted concepts from the target files may then be used to identify the statistically significant terms. Finally, with respect to target files that are comprised of an unstructured data set where entity extraction is not practical, the search composition module 200 may use the Hierarchical Agglomerative Clustering (“HAC”) algorithm to cluster documents from the data set. Each cluster of documents is given a representative label or concept. The labels may then be used as statistically significant terms.

The use of statistically significant terms rather than reliance on user input makes it possible to execute the initial search without any direct human judgement in the selection of the terms. Such an approach is particularly useful in instances where the credibility of the output is highly sensitive to the introduction of human judgment into the process. This includes, for example, instances where the core technology is used to review, search and/or analyze a corpus of data in legal proceedings, academic research, or public opinion research. Accordingly, the use of the methods and systems disclosed herein virtually eliminates any bias in the selection of the terms used for the initial search and instead, performs the initial search based on key terms that are gleaned from the target files. As would be appreciated by those of ordinary skill in the art, having the benefit of the present disclosure, this improved method and system has several advantages. For instance, in the context of a legal proceeding, a user may have a particular theory of the case at the outset with particular names, dates that in his (or her) view are deemed important. However, in many instances, that initial theory of the case may be incorrect, inaccurate or otherwise inconsistent with the contents of the key documents (i.e., target files) in the case. Using prior art methods and systems, the user would initiate the search based on those inaccurate theories. The user would then continue to operate under those inaccurate theories until potentially reviewing enough documents to realize that those theories were incorrect (e.g., the individuals deemed to be key witnesses were not in fact the key witnesses or the dates deemed to be key dates were not in fact key dates). In contrast, using the methods and systems disclosed herein, the initial search is orchestrated based on the contents of the target files without user intervention which as would be appreciated by those of ordinary skill in the art, having the benefit of the present disclosure, significantly improves the efficiency of the search process.

In accordance with a third implementation 206, a recursive approach may be utilized whereby the initial search parameters are derived from the results of prior concept extraction operations (as discussed above in conjunction with the operation of the search composition module 200) in the concept extraction module 400. Using one of the three implementations 202, 204, 206 discussed above or a combination thereof, the search composition module 200 generates search parameters 208 that are used by the core technology.

The concept extraction module 400 performs a search on the optimized corpus 108 using the search parameters 208 from the search composition module 200. Specifically, the concept extraction module 400 uses HAC to analyze the optimized corpus 108 by reference to the search parameters 208 and generates a nested hierarchy of concept clusters referred to herein as “initial concept clusters.” Each initial concept cluster is comprised of documents that are conceptually related to a common theme. In accordance with certain embodiments, statistical analysis is used to identify the documents that correspond to each initial concept cluster. Once the initial concept clusters are identified, they are in turn analyzed and placed in relationships with one another. In certain embodiments, the initial concept clusters may be displayed on a user interface to the user (in this case, the document reviewer) who can then perform the review using the hybrid review module 500.

The use of HAC algorithms is known to those of ordinary skill in the art, having the benefit of the present disclosure. An illustrative example showing the use of HAC to cluster documents will now be discussed in conjunction with FIGS. 1a, 1b and 1c. The utilization of HAC algorithms to cluster documents comprises of two steps.

First, a single cluster of documents is created. Specifically, documents that are similar in content (for instance, they may contain the same keywords or are about the same topic), are included in the same cluster. A mathematical formula referred to as a distance metric may be used to measure the “closeness” of the documents and documents that are deemed “close enough” are assigned to the same cluster. For example, documents that are all related to the American Civil War would all be in the same cluster. Documents are represented in a vector space and cosine measurement can be used to measure the “distance” between these vectors. Cosine is represented as a ratio between 1 and 0. A distance of 1 between vectors representing two documents would mean that the two documents are an exact match and a distance of 0 would mean the documents are not related at all. In the illustrative example of FIG. 1a , six separate document clusters are identified as a-f and represented in 2D space. In this example, the distance between clusters is measured in Euclidean distance, or ordinary straight-line distance between two points. Each cluster of documents may be labelled with a representative term. This could be an entity name or phrase that is common to all the documents in the duster. Though not required, the term could also be associated with a dictionary or taxonomy.

Next, once the document belonging to each cluster have been identified, each cluster will be treated as a vector and the distance between the clusters (which is referred to as the linkage metric) is determined in the same manner discussed above in conjunction with the first step. For instance, in the illustrative example of FIG. 1a , the linkage metric indicates that clusters b/c are closest to each other and that clusters d/e are closest to each other. Cluster f is close to clusters d and e. Finally, cluster a is furthest from the remaining clusters. The HAC clustering algorithm repeatedly combines small clusters into larger ones until there is one big cluster. Clusters with a strong linkage (clusters that are close to each other) will be combined before clusters with a loose linkage (clusters that are far from each other). FIG. 1b depicts the relationships between the clusters identified in FIG. 1A in a dendrogram. As shown in FIG. 1b clusters b/c and c/d are relatively close to each other so they are represented in the dendrogram at a higher level than say clusters e/f. Moreover, as shown in FIG. 1b, cluster a is far from the other clusters so it's not combined with the other clusters until the very root of the tree. FIG. 1c depicts an illustrative hierarchy of clustered documents with the cluster labels and number of documents in each cluster (shown in the circle next to each cluster label).

The hybrid review module 500 is the module that guides the reviewer through the review process using the initial clusters (and the relationships therebetween) as identified by the concept extraction module 400. The user may interact with the hybrid review module 500 through a user interface. In order to quantify a reviewer's understanding of the contents of the optimized corpus 108, a scoring system referred to herein as the “Snyder Scoring System” is used. Specifically, assuming a Snyder Scale of 0-100, the user utilizes the hybrid review module 500 to go from a point of total ignorance about the content of the optimized corpus 108 (corresponding to a Snyder Score of 0) to a point of comprehensive understanding about the content of the optimized corpus (corresponding to a Snyder Score of approximately 100). Importantly, as described in further detail below, the methods and systems disclosed herein allow a user to go from a Snyder Score of 0 to a Snyder Score of 100 (or substantially close thereto) by only reviewing a small percentage of the data in the optimized corpus 108 as opposed to having to review all the data. The calculation and use of the Snyder Score is discussed in further detail in conjunction with the use of the hybrid review module 500. As described in further detail below, a user can declare the review complete and terminate the review process once a desired Snyder Score is reached. The desired Snyder Score may be 100 or a number less than 100 depending on the user's preferences such as, for example, the urgency with which the review is to be completed.

The hybrid review process of the hybrid review module 500 starts with the user being provided with an arrayed set of concept clusters comprising the initial clusters and their relationships from the concept extraction module 400. The hybrid review process may be terminated by the user at any point. In accordance with certain illustrative embodiments, the user may elect to complete the review relying on the Snyder Score which provides a statistically valid basis for concluding the review even though only a small percentage of the optimized corpus has been subjected to human review. Accordingly, the use of the Snyder Score allows a user to conclude the review before the reviewing party has expended the time and money to have a human being look at every single document in the review corpus.

Reviewing documents, for instance in the context of a lawsuit, often entails a reviewer learning new facts and thinking about new issues as the review goes on. For instance, a reviewer may learn of a new fact based on the review of a given document that may instigate a desire to follow down a new previously unknown path of investigation. To address these issues, the hybrid review module 500 is designed to allow the reviewer to toggle between a review mode 502 and a search mode 520. The review mode 502 is a process optimized for methodical processing of a defined corpus. In contrast, the search mode 520 is a process optimized for free-form search and discovery. The details of operation of the hybrid review module 500 will now be discussed in further detail in conjunction with FIG. 1.

The operation of the hybrid review module 500 begins with the receipt of an arrayed set of initial concept clusters from the concept extraction module 400, with check-boxes next to each cluster. In the review mode 502, a user interface allows the user to perform the review. Specifically, the user starts the process by selecting the clusters (and/or sub-clusters) 504 that, in the user's judgment, appear to relate to the subject matter of the inquiry. For example, in the context of a lawsuit, the user may select the clusters and sub-cluster that pertain to the issues at dispute in the particular lawsuit depending on the facts of the case. Accordingly, the user can use the user interface to select one or more clusters (and/or sub-clusters) as the clusters of interest.

The user's selection of particular clusters at step 504 highlights the importance of those clusters to the particular inquiry at hand. For instance, in the context of a lawsuit, a user's selection of particular clusters is indicative of the fact that the issues reflected by those clusters are of particular importance to the lawsuit. Accordingly, at step 506, all the files (also referred to as documents) in the optimized corpus that correspond to the clusters selected at step 504 receive an initial relevancy boost and in the background, the relevancy ranking of all documents is recalculated accordingly. Stated otherwise, the data (i.e., documents or files) corresponding to the important issues receive a boost in relevancy ranking compared to the documents that are not relevant to the particular issues reflected by the selected clusters.

Following the relevancy boost, the files in the optimized corpus are ranked in order of relevancy and shown to the user in a ranked order at 508. Accordingly, the user is first shown the document determined to be most relevant on a user interface at step 508 and an iterative looping process is initiated. The most relevant document is determined algorithmically using HAC, as guided by the search parameters generated from the search composition module 200. Relevancy can be boosted in a number of different ways depending on the structure of the data set. For instance, for a data set that has some metadata or fielded data like a title field, keywords or concepts that match a term in the title field can boost that document over other documents. For data sets with no metadata or fielded data, unstructured text can be matched to give a boost to the given document. In response to the most relevant document being displayed at step 508, the user can instruct the information handling system to perform a number of commands at 510. For example, if reviewing documents on a legal platform in the context of a lawsuit, the user may tag the displayed document with one or more of the following designations: (1) “Irrelevant”: indicating that the document is not relevant to any issues in the lawsuit; (2) “Relevant”: indicating that the document is relevant to the issues in the lawsuit; (3) “Hot”: indicating that not only is the document relevant to issues in the lawsuit, but it is a key document of particular importance; or (4) “Privileged”: indicating that the document is subject to attorney-client privilege (or other privilege) and therefore, should not be produced to the other side or should be redacted. As would be appreciated by those of ordinary skill in the art having the benefit of the present disclosure, the present disclosure is not limited to the specific designations provided herein. Accordingly, additional suitable designations may be used depending on the particular application or a subset of the listed designations may be used without departing from the scope of the present disclosure.

Additionally, the user may utilize the user interface to indicate that the document displayed is associated with one or more predefined elements (e.g., Element 1, Element 2, Element 3, etc.). Each of these elements may relate to a corresponding issue in the case such as, for example, the elements of a party's claims or defenses. For example, an element may be a statement like “The board of directors knew about the contract.” During the review process the reviewer may then have the opportunity to associate documents with the element to determine if that statement is true or false. At the end of the review process, the reviewer can then display or visualize each of the elements and the associated documents. Alternatively, after reviewing the document identified as most relevant at 508, the user may undo the designation of the particular document as such and move on to the next most relevant document.

In accordance with certain illustrative embodiments, when the user applies a relevancy designation (e.g., “Relevant”, “Hot”, “Irrelevant”), the user is also able to assign the document to one or more of the predefined elements (e.g., Element 1, Element 2, Element 3, etc.). For instance, if a document is designated as “Hot”, the user may be prompted to assign the document to one or more of the predefined elements. Optionally, at 512 the user may also submit a note regarding the document for example, explaining the relevance of the document or the reason the document is believed to be a “Hot” document. In certain illustrative embodiment, the user may submit a voice note instead of a written note and the voice note may be transcribed into text and associated with the particular document.

Next, at 514, the remaining documents (i.e., those that have not been manually reviewed and tagged by the user) in the optimized corpus 108 are analyzed and ranked in accordance with the user's input at 510 regarding whether the reviewed document has been designated as “Hot.” Specifically, if the particular document displayed and reviewed by the user at 510 is designated as “Hot” all other documents in the optimized corpus may be analyzed and each document's relevancy ranking may be updated in terms of statistical similarity to the reviewed document. The statistical similarity between each document in the optimized corpus 108 and the reviewed document may be determined based on a variety of factors including, but not limited to, the unstructured text, available metadata (e.g., author, date, recipient, etc.), and/or similarity of key terms. The documents that are statistically similar to the designated “Hot” document are given a relevancy boost in proportion to their degree of similarity. Thus, a document with a statistical similarity of 90% to the designated “Hot” document receives a relevancy boost that is slightly larger than another document within the corpus having 80% statistical similarity to the designated document. As discussed above in conjunction with the corpus optimization module 100, identical documents which would be 100% statistically similar would have been removed during the optional de-duping process in that module.

Next, at 516, the relevancy ranking of the optimized corpus is updated based on the relevancy of the reviewed document. Specifically, if the particular document being displayed and reviewed by the user at 510 is designated as “Relevant” or “Hot” the remaining documents in the optimized corpus are analyzed and each document's relevancy ranking may be updated in terms of statistical similarity to the reviewed document in a manner similar to that of step 514. The documents that are statistically similar to the reviewed document will receive a boost in relevancy ranking in the optimized corpus 108. In accordance with certain implementations, because a “Hot” document is deemed to be more important than a document that is only “Relevant”, documents that are statistically similar to a “Hot” document receive a higher ranking than documents that are statistically similar to a “Relevant” document. Specifically, the documents that are similar in characteristics to the selected document are identified and receive a relevancy boost. In certain illustrative embodiments, if the particular document being displayed and reviewed by the user at 510 is designated as “Irrelevant” the remaining documents in the optimized corpus are analyzed and each document's relevancy ranking is updated in terms of statistical similarity to the reviewed document such that the documents that are statistically similar to the reviewed document receive a demotion in ranking in the optimized corpus.

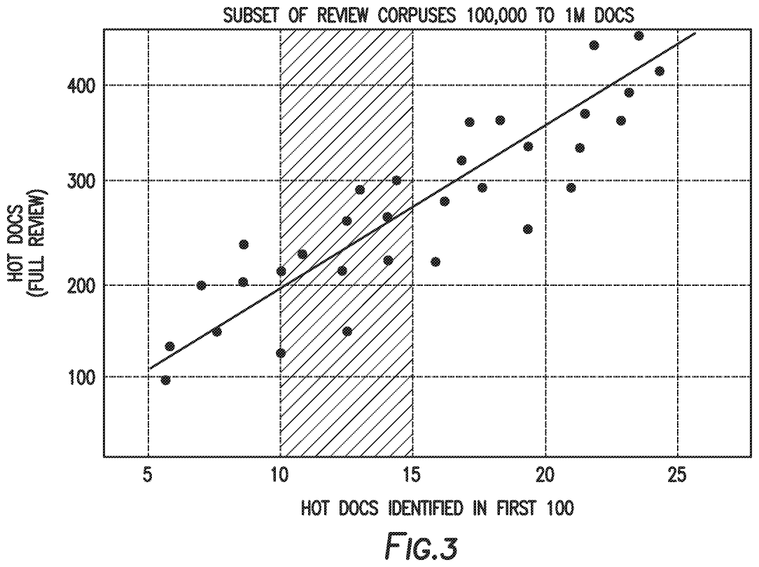

Accordingly, following steps 514 and 516, the optimized corpus 108 is re-ranked based on the user's review of the particular document at step 508. Additionally, the Snyder Score is updated after each iteration at the Snyder Module 518. The details regarding the derivation and use of the Snyder Score are described in detail in conjunction with FIGS. 2-4. The process then returns to step 508 whereby the document having the highest relevancy ranking that has not been reviewed is displayed to the user for review and the loop is repeated. This loop consisting of steps 508, 510, 514, and 516 is referred to herein as the “Review Loop.” The Review Loop is repeated until either a predetermined Snyder Score is achieved at Snyder Module 518 or the user otherwise deems the review complete.

As each document is displayed for review by the user at 508, it is possible that the user may encounter a document that leads to a desire to make independent, self-guided searches in the optimized corpus 108. To that end, methods and systems disclosed herein allow the user to toggle out of the review mode 502 and into a search mode 520.

In the search mode 520, the user may be provided with a search box and a user interface to execute a search query on the optimized corpus 108. In certain illustrative embodiments, the user may execute the search by, for example, entering search terms, a Boolean search string or using voice commands. In response to the search query executed by the user, corresponding search results are displayed on the user interface. In accordance with certain illustrative embodiments, the search results may be comprised of an array of extracted concept clusters and sub-clusters generated using HAC in a manner similar to that discussed in conjunction with the operation of the concept extraction module 400. In certain implementations, the search results may also include a list of documents containing the particular search terms used in the search query corresponding to each extracted cluster and/or sub-cluster. The list of documents may be ranked with the documents most relevant to the particular search query listed first. In certain illustrative embodiments, the user may select a particular cluster and/or sub-cluster at 522 to display the list of documents generated in response to the search query that fall in that cluster and/or sub-cluster.

At 524, the user may select a document in the search result list corresponding to a selected cluster and/or sub-cluster and the document is displayed for user's review. Next, at 526, the user may tag the document displayed with one or more relevancy designations and predefined elements in a manner similar to that described in conjunction with 510. The user may also append hand written or voice notes to the particular document at 512 as discussed above. Accordingly, the user can selectively toggle between the search mode 520 and the review mode 502 as desired throughout the analysis of the optimized corpus.

The operation of the hybrid review module 500 is completed when the reviewer declares the review completed and enters the visualization module 600. The user may choose to end the review at any point. In certain illustrative embodiments, the user may choose to end the review when the Snyder Score reaches 100 (or any other score the user deems acceptable) providing a defensible and empirically valid basis for terminating the review.

In accordance with certain illustrative embodiments, the core technology includes an element assessment module 300. The element assessment module 300 may contain a user supplied list of elements that are deemed to be relevant to a particular inquiry. For instance, in the context of a lawsuit, the list of issues/elements included in the user supplied list of the element assessment module 300 may include a list of the names of the key individuals, the key words associated with the parties' claims and defenses, key dates, etc. Accordingly, upon completion of the review by the hybrid review module 500, the information provided in the element assessment module 300 may be used to automatically associate the documents designated as “Hot” with the key elements of interest.

Following the completion of the review by the hybrid review module 500, the visualization module 600 visualizes the results of the review, search and analysis of the raw data in the data corpus. Specifically, the visualization module 600 collects the data generated by the user's interaction with the optimized corpus 108 and displays the generated data in a manner to enable the user to comprehend the overall result of the review and identify specific areas where further review/analysis may be necessary. Any such further review/analysis may then be performed using the search mode 520 of the hybrid review module 500. The visualization module 600 may visualize the results of the review at 602 in one or more specific configurations to permit the user to digest the documents identified following the operation of the hybrid review module 500. In certain illustrative embodiments, the visualization module 600 may display the generated data from the reviewed and documents that have been determined to be of interest in one or more of the following display configurations: (1) organized by individuals or entities of interest 604 which in the context of a lawsuit, may include a display of documents associated with key witnesses or entities of interest in the particular lawsuit; (2) organized by date 606 which in the context of a lawsuit, may include the display of a timeline of key events during a time period of interest and the document(s) associated with each entry on the timeline; (3) organized by element 608 which in the context of a lawsuit, may include the display of documents relevant to key issues relevant to the elements of the parties' claims and/or defenses; and (4) organized by relevancy designation 610 which in the context of a lawsuit, may include the display of documents that are deemed relevant, irrelevant, hot, or privileged. As would be appreciated by those of ordinary skill in the art, having the benefit of the present disclosure, these configurations are provided for illustrative purposes and are not intended to provide an exhaustive list of configurations that may be visualized by the visualization module 600. Accordingly, additional configurations may be visualized or a subset of the listed configurations may be visualized depending on the particular implementation without departing from the scope of the present disclosure.

In accordance with certain illustrative embodiments, the visualization module 60 also permits the export of files from the corpus of data or the generation and export of reports characterizing the data corpus at 612. For instance, in certain illustrative embodiment, the visualization module 60 may generate reports summarizing all or certain aspects of the results of the review performed. For example, the workflow enables generation of a report of potentially privileged documents (e.g., documents that would have come up for review, but were diverted due to their fitting a prescribed set of criteria, such as having a particular lawyer as the sender or recipient, or in the case of raw spoken-word data, having the extracted vocal fingerprint of the voice of a person known to be a lawyer). For example, in the context of a lawsuit, documents of interest may be exported as evidence items each having an electronic note card which may, for example, aggregate any voice notes, handwritten notes, relevancy ratings, extracted metadata, etc. associated with the particular document. The user may then use a user interface to drag the evidence items as desired from one location to another or create folders, etc.

In accordance with certain illustrative embodiments where it is desirable to facilitate a large-scale document review, the methods and systems disclosed herein will enable the visualization of results of reviews performed by multiple reviewers into a single unified dashboard. Accordingly, the aggregate progress of the review can be visualized in one place

Accordingly, the core technology of FIG. 1 uses HAC to automatically and iteratively refine the algorithm used to rank the importance of the data in the optimized corpus “on the fly” based on the organic review decisions of a user. As would be appreciated by those of ordinary skill in the art, having the benefit of this disclosure, this approach results in the user being shown a high concentration of hot and potentially relevant documents in the early stages of the review process. As a result, the core technology of FIG. 1 maximizes the time a user spends interacting with the most relevant documents and minimizes the time spent reviewing irrelevant documents.

The Snyder Score is a metric, expressed on a scale, that measures the progress a reviewer has made towards identifying and designating every key (or “Hot”) document within a given corpus of data. While the present disclosure is not limited to any particular range for the Snyder Score scale, in accordance with an illustrative embodiment of the present disclosure, the Snyder Score scale may range from 0-100. However, any other desired range for the scale may be used without departing from the scope of the present disclosure. The Snyder Score is a metric derived from a meta-analysis of document reviews in multiple cases on a given legal platform. The details regarding the derivation and updating of the Snyder Score at Snyder Module 518 will now be discussed in conjunction with FIGS. 2-4.

In order to derive the Snyder Score, user data is collected with respect to various reviews on a review platform using the core technology regarding (1) the total number of documents in the corpus in each review project; and (2) the user's responses (“Hot”, “Warm” (Relevant), “Cold” with respect o every document reviewed by the user in each project.

In accordance with an illustrative embodiment of the present disclosure, the Snyder Score will be initially seeded as follows. As discussed above in conjunction with the hybrid review module 500, the review process disclosed herein continuously boosts relevant documents to “the top” of the review stack. This feature facilitates the use of the Snyder Score and the justification for stopping a review early when a particular Snyder Score is achieved.

The Snyder Score is seeded by conducting a number of “test” reviews of varying sizes and compositions. An illustrative dataset is now used to describe the seeding of the Snyder Score. As would be appreciated by those of ordinary skill in the art having the benefit of the present disclosure, this example is provided for illustrative purposes only and is not intended to impose a limitation on the scope of the present disclosure. For each individual test review (and every review thereafter) using the review tool, the following anonymized data will be retained for purposes of refining the Snyder Score algorithm:

| Document ID | Number in Sequence | User Decision |
|---|---|---|
| email012 | 1 | Cold |
| email943 | 2 | Hot |
| email934 | 3 | Warm |
| email95543 | 4 | Cold |
| pdf594 | 5 | Hot |
| voicemail34 | 6 | Cold |
| email43 | 7 | Warm |
| email4954 | 8 | Cold |
| pdf493 | 9 | Hot |
| pdf494 | 10 | Hot |

The table above includes 3 different columns. The first column represents the “Document ID” which may be any unique identifier that identifies a particular document in the corpus. In the illustrative example shown here, the Document ID may be the file name. The second column represents the “Number in Sequence” which indicates the order in which the corresponding document is shown to the user. For instance, in the illustrative example of the table above, the document “email012” was the first document shown to the user, the document “email943” was the second document shown to the user, and so on. The third column represents the “User Decision” which represents the user's evaluation of the particular document. For instance, in the illustrative Example of the table above, the user may designate a document as irrelevant (i.e., “Cold”), relevant (i.e., “Warm”), or relevant and of particular importance to the issues in the case (i.e., “Hot”). In addition, more granular data concerning the extent to which boosting affects rankings within the corpus in the aggregate (as measured over the course of a review) will be retained and used to construct a parallel metric for describing the completeness of review and measuring the efficacy of the boosting algorithm.

The Snyder Score is initially constructed once there is a statistically significant number of user reviews. Thereafter, as the system receives more user data, it further refines the Snyder Score. Accordingly, the Snyder Score will continuously be refined and updated over time as the system is used.

FIG. 2 depicts an illustrative graph demonstrating this information for a given review platform. Specifically, the X-axis indicates the number of documents in the corpus for a given review project and the Y-axis indicates the corresponding total number of documents tagged as “Hot” by the user upon completion of each given review project. The data points on the chart in FIG. 2 may be generated based on historical data regarding various review projects performed using the core technology on the particular review platform. The specific data points and values on the scale in FIG. 2 (as well as the remaining figures discussed herein) are hypothetically selected for illustrative purposes only and are not intended as a limitation on the scope of the present disclosure. Relying on these data points, a best fit curve is derived as shown in FIG. 2. This best fit curve is derived so as to enable an initial estimate of the number of “Hot” documents in a corpus based solely on the size (i.e., number of documents) of the corpus.

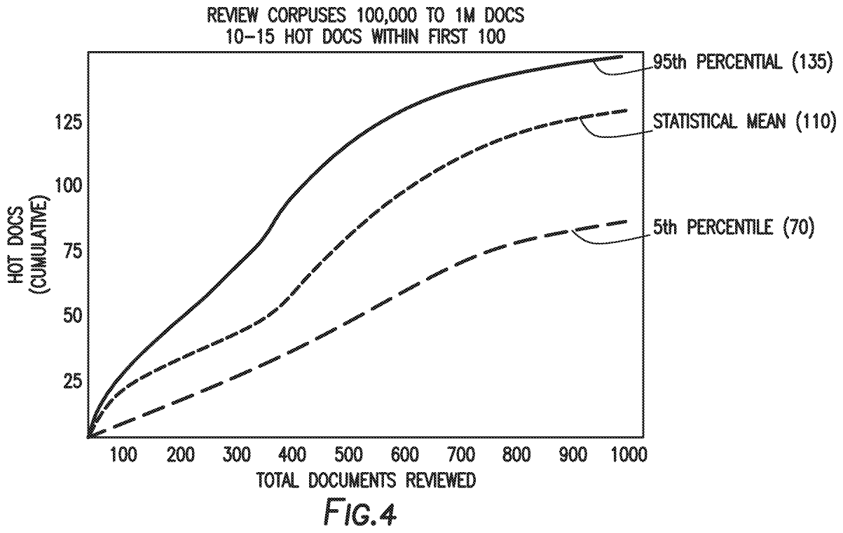

As the reviewer tags additional document in the review mode 502 of the hybrid review module 500 during an ongoing review project, the core technology iteratively refines its estimate of the number of “Hot” documents within the corpus. Specifically, the system keeps track of the number of documents marked “Hot” by the user on ongoing basis in the review at hand and uses this information to determine the percentage of documents heretofore marked “Hot” at any given point in time during the review. The percentage of documents tagged as “Hot” after reviewing any given number of documents in the corpus is referred to herein as the “Current Hot Percentage.” Based on historical data from prior review projects performed using the review platform, the system can then identify prior reviews which had a corpus size similar to the current corpus size and a similar Current Hot Percentage. This concept is demonstrated in conjunction with FIG. 3.

FIG. 3 depicts an illustrative graph that may be used by the core technology to adjust the estimate for the total number of “Hot” documents expected in the corpus after 100 documents have been reviewed and tagged by the user in the review mode 502. Specifically, FIG. 3 shows the historical data for review projects performed on the review platform having a corpus size of between 100,000 documents to 1 million documents. With respect to each of the reviews with a corpus size falling in this range, the X-axis reflects the number of documents that were tagged as “Hot” after the user had reviewed 100 documents and the Y-axis reflects the total number of “Hot” documents in the corpus upon completion of the review project. Assuming that the corpus size for the data currently being reviewed falls within the range covered by the graph of FIG. 3, then this is the chart the core technology will use to update the estimate of total number of “Hot” documents in the corpus after 100 documents have been reviewed and tagged by the user in the review mode 502. For instance, in the illustrative embodiment of FIG. 3, if the Current Hot Percentage after reviewing 100 documents is 10 documents (X-axis), the core technology will estimate the total number of hot documents in the corpus to be somewhere between 120 and 210 documents (Y-axis). This estimate will iteratively be updated with each document reviewed by the user in the review mode 502 in real-time. Accordingly, as more documents are reviewed by the user, the estimate for the total number of “Hot” documents in the corpus becomes more accurate on ongoing basis. From this data, the core technology can continuously establish a probable range for the number of “Hot” documents that remain to be reviewed and identified.

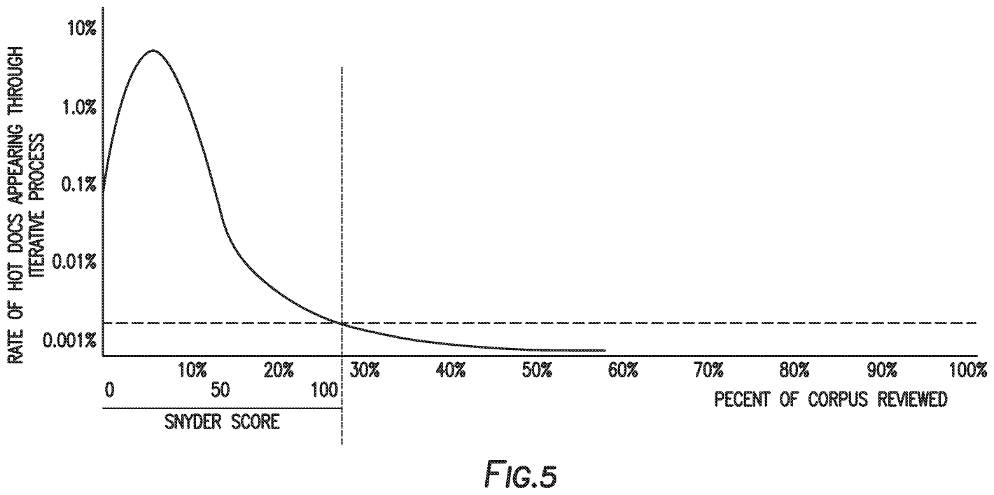

Turning now to FIG. 4, a hypothetical data set regarding the total number of hot documents vs. the total number of documents reviewed in past reviews on the review platform for a corpus containing a range of between 100,000 documents and 1 million documents is depicted. The data points of FIG. 4 are generated using charts similar to FIG. 3 which reflect the number of “Hot” documents identified in various prior review projects following a user's review of a given number of documents. The specific data set of FIG. 4 corresponds to prior reviews on the review platform where 10-15 documents in the first 100 documents reviewed were marked as “Hot” by the user which implies a hypothetical range (with 5% margin of error) of 70-135 “Hot” documents in the corpus, with a statistical mean of 110. This computation is re-calculated at regular intervals, generating progressively narrower ranges.

In accordance with an illustrative embodiment of the present disclosure, the core technology maintains a trailing average frequency of “Hot” documents over a segment equal to approximately 1% of the corpus at Snyder Module 518. Accordingly, if the corpus contains 50,000 documents, what is considered at every point is the frequency with which “Hot” documents have been identified over the last 500 documents reviewed (i.e., the “Rolling Average”). As would be appreciated by those of ordinary skill in the art, although a 1% segment is used in the illustrative embodiment, the present disclosure is not limited as such and a larger or a smaller segment may be used without departing from the scope of the present disclosure. The Rolling Average determined by the Snyder Module 518 is then compared with a CutOff Average which is defined as follows:

$$Cutoff Average = \frac{Hot Docs Designated + Predicted Hot Docs Remaining}{Total No . of Docs in Corpus}$$

where “Hot Docs Designated” is the number of documents currently tagged as “Hot” by the user; “Predicted Hot Docs Remaining” is the number of “Hot” documents that the Snyder Module 518 predicts remain to be tagged based on its analysis as discussed in conjunction with FIGS. 2-4; and the “Total No. of Docs in Corpus” is the total number of documents in the corpus of data being reviewed by the core technology.

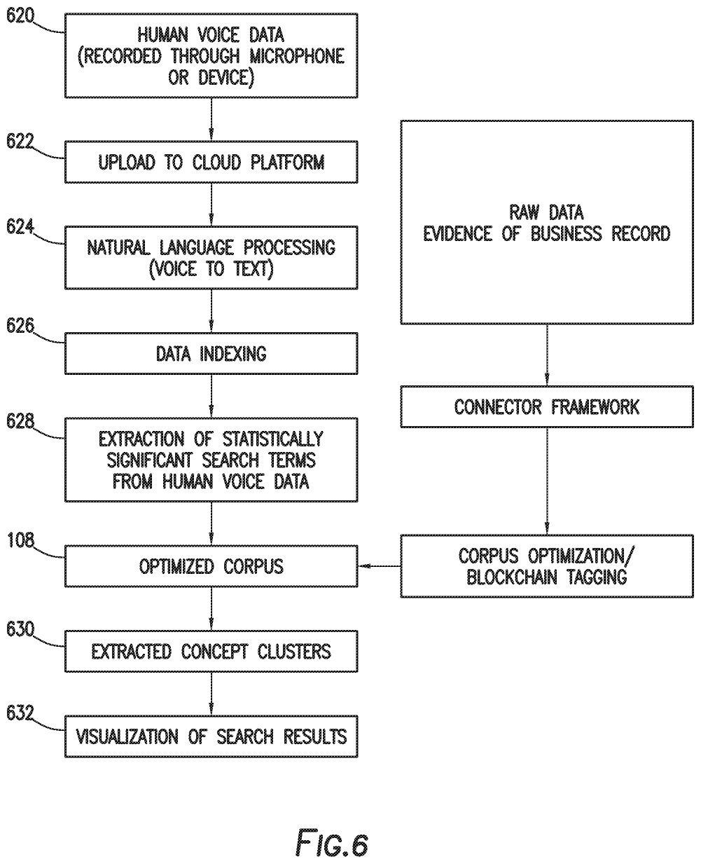

The conceptual review curve of FIG. 5 depicts the contrast between a review implementing the Snyder Score in accordance with an embodiment of the present disclosure and a traditional review process in accordance with the prior art. Specifically, the X-axis indicates the number of documents in the corpus that have been reviewed and the Y-axis indicates the rate at which “Hot” documents are identified as the review is progressing.

The flat, horizontal line corresponds to the Cutoff Average and reflects a traditional review process in accordance with the prior art where documents are presented to the reviewer in a static order, unaffected by the reviewer's ongoing analysis and tagging of reviewed documents. When implementing such a traditional review, information regarding relevance of a reviewed document has no impact on the subsequent documents to be reviewed. Accordingly, the rate at which “Hot” documents are identified remains essentially constant as the review process continues and the substantial majority, if not all, of the documents in the corpus must be reviewed in order to identify the substantial majority of the “Hot” documents.

In contrast, the curved line corresponds to the Rolling Average and reflects a review in accordance with an embodiment of the present disclosure. As discussed above in conjunction with FIG. 1, the core technology dynamically recalculates the relevance ranking of the documents in the corpus in real-time as the reviewer reviews and tags each document. Consequently, “Hot” documents are continuously pushed to the front of the review queue and “Hot” documents are identified at a high initial rate as indicated by the curved. A large number of “Hot” documents are identified at the beginning of the review process. However, the rate at which “Hot” documents are identified decreases as the review progresses because the “Hot” docs are pushed to the front of the review queue.

As shown in FIG. 5, there is a point where the curve reflecting the review using the methods and systems disclosed herein intersects the flat line reflecting the traditional review (referred to as the “Cross Point”). After the Cross Point, finding an additional “Hot” document in the corpus using the iterative adaptive core technology is no more probable than reviewing the documents in random order using a traditional review. Stated otherwise, once the Cross Point is reached, the iterative review process by the core technology is no longer cost-effective and any further review may be more prudently conducted using a targeted approach such, as for example, by performing specific searches.

A Snyder Score of 100 corresponds to this Cross Point between the Rolling Average and the Cutoff Average as shown in FIG. 5. More specifically, the Snyder Score is calculated by the Snyder Module 518 as follows. For the initial X percentage points of the Snyder Score, the progress will be solely a function of the ratio between the “Hot Docs Designated” and “Predicted Hot Docs Remaining.” This is a more useful estimation of the overall review progress in the early stages of the review process. As the review process continues and the Snyder Score nears completion, this metric phases out and the final portion of the Snyder Score will be based upon the ratio of the Cutoff Average and the Rolling Average. By definition, the Snyder Score reaches 100 at the point when continued review using the core technology is no more productive than searching the documents at random and the Rolling Average converges with the Cutoff Average.

The Snyder Score will be constructed in the fashion described in “Derivation and Use of Snyder Score” and shall be continuously refined. At the beginning of any review, the total corpus size is known. After a given number of documents are reviewed (for example, the first 100), another fact is known: how many hot documents were selected? At this point, data from prior reviews of similar corpus size and similar number of documents marked hot (out of the first 100). Importantly, for every prior review, we will also know how many “hot” documents were eventually found. Based on that data, we can create a range of hot docs that likely exist within the particular corpus under review. As the review continues, the estimated number of hot docs is continually re-calculated and refined. Accordingly, using the Snyder Score in conjunction with the methods and systems disclosed herein, most (if not all) the key documents/files in the corpus may be identified after reviewing a small subset of the documents/files in the corpus without reviewing all the documents or having to perform manual searches. Therefore, the methods and systems disclosed herein provide a significant advantage over prior art methods of reviewing documents/files in a corpus. As would be appreciated by those of ordinary skill in the art, utilization of a Snyder Score in this manner is not possible when users review a corpus of data without the use of an information handling system. Moreover, prior art methods and systems for reviewing a data corpus which did use an information handling system do not disclose the utilization of the Snyder Score in the manner disclosed herein and therefore, cannot achieve the efficiency and speed resulting from the disclosed approach.

The core technology described in conjunction with FIG. 1 may have many applications including, but not limited to, implementation in conjunction with a legal platform and a media platform. Additional applications include, but are not limited to, forensic accounting, corporate due diligence, and regulatory compliance.

The use of the core technology in a legal platform allows legal professionals to review documents (including those having text and/or spoken-word) in an improved efficient and effective manner. The implementation of the core technology of FIG. 1 in a legal platform would be evident to those of ordinary skill in the art, having the benefit of the present disclosure, in light of the specific examples provided above regarding the use of the core technology in the context of a lawsuit. The core technology can similarly be used in transactional context where it is desirable to review a large corpus of data relevant to a transaction in an efficient and effective manner.

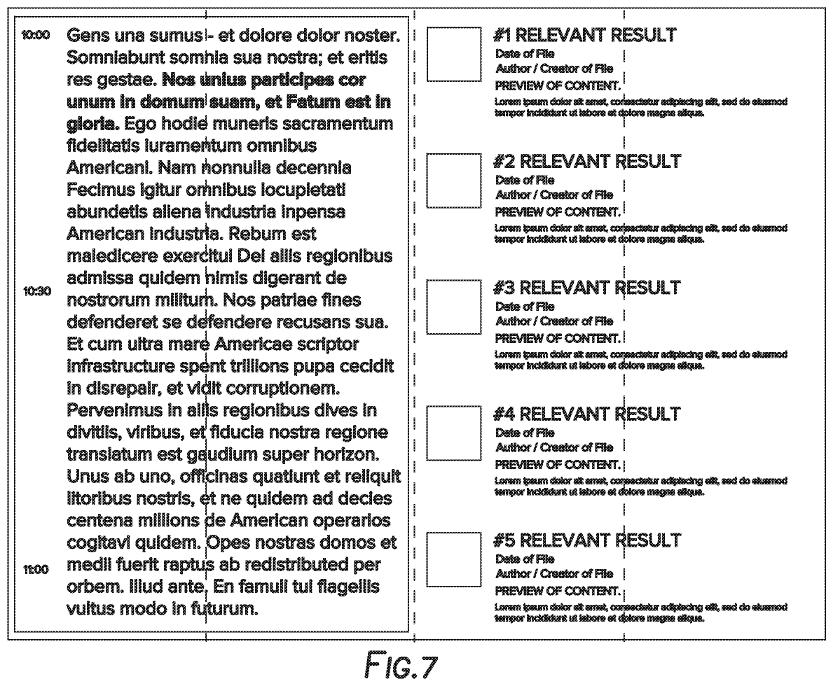

In accordance with certain illustrative embodiments, the visualization module 600 of the core technology may further include a Dynamic Relevancy Display (“DRD”) subsystem 614. The DRD subsystem 614 can receive terms, in real time, and display a list of documents from the optimized corpus 108 (or a subset thereof as selected by the user) with the highest statistical probability of relating to those terms. For example, in certain illustrative embodiments, the terms may be derived from words spoken into a microphone by a user. The DRD subsystem 614 can then display a list of documents with the highest statistical probability of relating to the words that were recently spoken. The details of operation of the DRD subsystem 614 will now be discussed in conjunction with FIG. 6. The methods and systems described in conjunction with the DRD subsystem 614 may be implemented using an information handling system.

The DRD subsystem 614 operates on the optimized corpus 108. An illustrative embodiment of the DRD subsystem 614 will now be described in further detail in conjunction with an application in the legal platform. Specifically, in one exemplary application may be desirable to identify the most relevant documents relating to oral testimony of a witness during a deposition in real-time. However, the present disclosure is in no way limited to this particular illustrative example. The same method and system may be used in any other platform and many other applications where it is desirable to identify the documents or files most relevant to spoken words in real-time without departing from the scope of the present disclosure.

In the illustrative embodiment of FIG. 6, as the witness speaks, the human voice data is recorded at step 620 through a microphone. The recorded voice is then uploaded in real-time to a computer readable media, such as, for example, a cloud server at step 622. At step 624, natural language processing is performed on the recorded voice using a high-speed voice-to-text Application Programming Interface (“API”) which converts the recorded voice into text in real-time. Next, at step 626 the recorded voice which has now been converted to text is used to generate multiple sequential transcripts of short periods of uploaded speech. Each of the generated transcripts is then analyzed using HAC and the statistically significant terms are extracted as the “key terms” in the recorded speech at step 628. Specifically, using natural language processing techniques, like entity extraction, key terms can be identified from unstructured text. These “key terms” may then be used to identify the “hot documents” that are most relevant to the witness' testimony as it is being rendered and recorded in real time. Specifically, at step 630 the key terms are used as search terms in a HAC search engine, which queries the optimized corpus 108 and extracts concept clusters. The concept extraction module 400 of the core technology which is described in further detail in conjunction with FIG. 1 may be used at this step. The search results may then be visualized at step 632 using the visualization module 600 of the core technology as described in further detail in conjunction with FIG. 1. Specifically, the visualization module may use the extracted concept clusters to generate, in real-time, a ranked list of documents that are statistically similar to the text of the words that have been recently spoken.

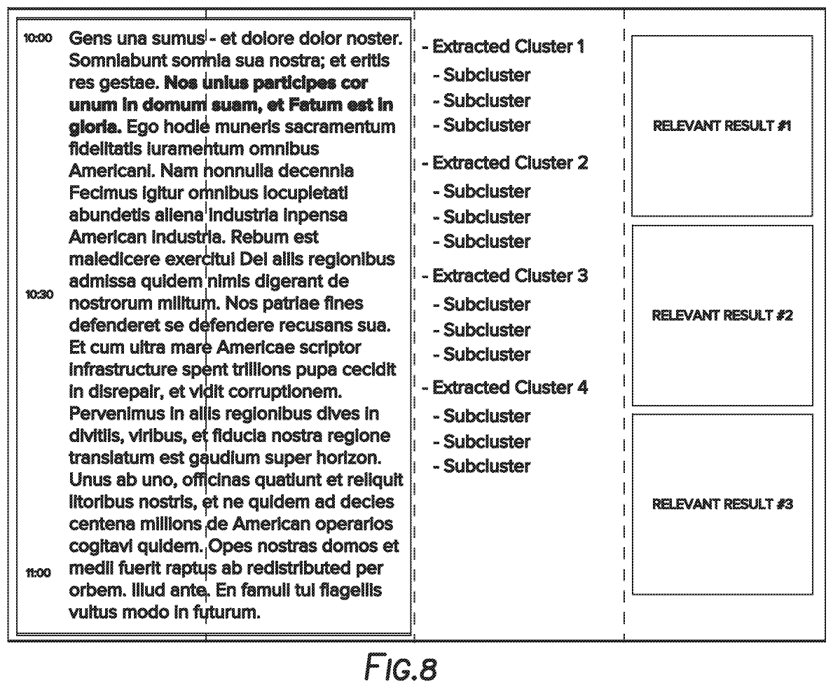

FIGS. 7 and 8 depict an illustrative example of the visualized output provided on the user interface of an information handling system by the DRD subsystem 614 in accordance with an illustrative embodiment of the present disclosure. FIGS. 7 and 8 are examples of two different visualizations of the same data in accordance with an illustrative embodiment of the present disclosure. In FIG. 7, the left-hand side of the screen depicts the display of transcribed voice data. Thus, in this example, a speaker's words are recorded, uploaded, transcribed, and indexed in real time using a natural language processing API. Using HAC, the statistically significant terms used by the speaker are extracted in real time and used to populate a search of the target corpus. For example, the spoken word data might be trial testimony, and the target corpus might be all of the trial exhibits and deposition transcripts in a legal lawsuit. In the visualization depicted in FIG. 7, the technology returns search results in relevancy order, without displaying concept clusters. FIG. 8 depicts substantially the same process, except that the right-hand side of the screen also displays the extracted concept clusters. FIG. 7 and FIG. 8 represent functional trade-offs between granularity (as provided by the concept clusters in FIG. 8) and reduction of screen clutter (as provided by FIG. 7). In cases involving large and highly technical corpuses, the concept clusters in FIG. 8 may be useful. In simpler cases, where the trial environment requires lawyers to be nimble, the FIG. 7 visualization may be superior. Accordingly, at all times during a witness' testimony, the DRD subsystem 614 allows a user (e.g., lawyers or judges in this illustrative example) to view a continuously updated list of documents that relate to the oral testimony being provided in real-time. As would be appreciated by those of ordinary skill in the art, having the benefit of the present disclosure, the examples in FIGS. 7 and 8 are provided for illustrative purposes only and the present invention is not limited to these particular implementations. Specifically, the display may be modified to show additional information (or less information) without departing from the scope of the present invention.

The use of the DRD subsystem 614 in conjunction with the core technology may, for example, be particularly beneficial in the legal platform. For example, the DRD subsystem 614 may be used in a legal proceeding where a witness is providing oral testimony in a deposition, hearing, or at trial. Utilizing the core technology, the user may load all the case documents (or exhibits) as raw data in the corpus optimization module 100. These documents may then be processed by the core technology as described in conjunction with FIG. 1. When a witness is providing oral testimony during the legal proceeding, the spoken words (i.e., questions and answers exchanged between the examiner and the witness) are indexed and statistically significant terms may be extracted therefrom by the DRD subsystem 614. In accordance with certain embodiments of the present disclosure, the DRD subsystem 614 uses the extracted terms to run a search on the optimized corpus using HAC and generate a rank list of documents that are statistically similar to the text of the words that have been recently spoken. Accordingly, a user can continuously review the documents that are most relevant to the oral testimony being provided and use those documents as desired.

Similarly, the DRD subsystem 614 may be used in a legal proceeding where the parties are presenting oral arguments to the court. In such instances, the motion papers and the exhibits related thereto may be loaded as raw data into the corpus optimization module 100. In a manner similar to that described above with respect to oral testimony, the DRD subsystem 614 may then keep track of and identify—in real-time—the key documents or statements in the record that are relevant to the arguments being presented to the court.

As would be appreciated by those of ordinary skill in the art, having the benefit of the present disclosure, the use of the DRD subsystem 614 is not limited to the illustrative examples provided in the context of a legal platform. Specifically, the DRD subsystem 614 may be used for other applications in a legal platform as well as for applications outside of a legal platform. For instance, the DRD subsystem 614 may be used in any applications where it is desirable to identify and monitor key data or documents relating to spoken words in real-time such as, for example, fact checking a speech or analyzing a congressional hearing in real-time. As would be appreciated by those of ordinary skill in the art, having the benefit of the present disclosure, the process would mirror that described above while the raw data loaded and used by the corpus optimization module 100 may differ depending on the particular application.

The core technology described in conjunction with FIG. 1 also has widespread application to a media platform where it is desirable to analyze, search, and/or review media content. The recent technological advancements have resulted in an increasing number of individual self-broadcasters and citizen journalists who often lack the resources of traditional media companies. Moreover, the materials published by such self-broadcasters and citizen journalists often contains a wealth of information that is for the most part, not traditionally harvested and used.

For instance, in accordance with an illustrative embodiment of the present disclosure, the raw data loaded and used by the corpus optimization module 100 may be self-broadcasting content podcasts, etc.). In accordance with this embodiment, the user may play an audio or video file. The spoken words from the audio or video file being played may then be used by the DRD subsystem 614 to generate a dynamic list of related self-broadcasting content in real-time in the same manner discussed above in conjunction with the legal platform.

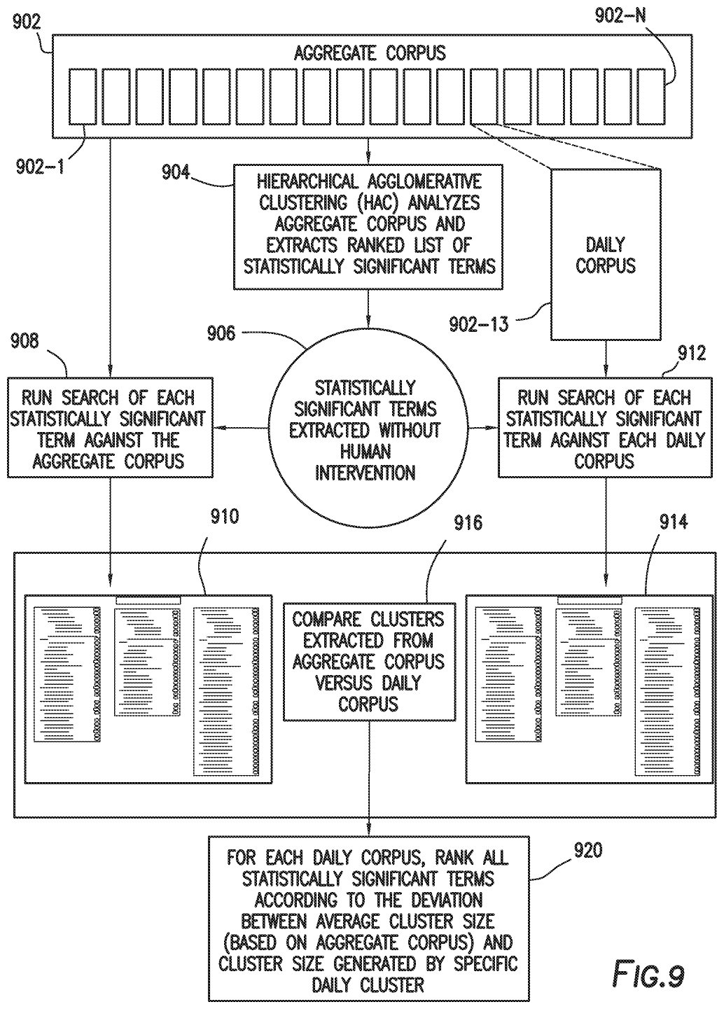

The utilization of the core technology in conjunction with the media platform may further entail the use of a Public Sentiment Engine. The Public Sentiment Engine uses HAC to extract statistically significant terms over time in the same manner discussed above in conjunction with the search composition module 200. The extracted terms may then be leveraged to quantify and measure changes in public sentiment on one or more given issues over time. Accordingly, the Public Sentiment Engine may be used to measure, analyze and monitor sentiment over time. The details of operation of the Public Sentiment Engine will now be discussed in conjunction with FIG. 9. The methods and systems described in conjunction with the Public Sentiment Engine may be implemented using an information handling system.

As shown in FIG. 9, the Public Sentiment Engine uses an Aggregate Corpus 902 as a raw input. The Aggregate Corpus 902 may constitute a large volume of audio and/or video content (e.g., podcasts, video posts, etc.) created by self-broadcasters on daily basis. In accordance with an illustrative embodiment of the present disclosure, the content uploaded by self-broadcasters is converted to searchable text using natural language processing. For instance, in certain illustrative embodiments, the natural language processing software used may include IBM Watson Natural Language Understanding tools, and the searchable text is stored in the Aggregate Corpus 902 on daily basis (902-1 . . . 902-N) over any desired period of time. Although the present embodiment is described in conjunction with the Aggregate Corpus 902 being divided into daily segments, the present disclosure is not limited to this particular implementation. Accordingly, any other segments of time may be used. For instance, depending on the particular application, the Aggregate Corpus 902 may be divided, for example, into hourly, weekly, monthly or annual segments without departing from the scope of the present disclosure. In certain illustrative embodiment the generated searchable text may be indexed and any associated metadata (e.g., timestamp, author name, location where it was posted, etc.) may also be stored therewith.

As would be appreciated by those of ordinary skill in the art, having the benefit of the present disclosure, the volume of content in the Aggregate Corpus 902 should be sufficiently large in order for the Public Sentiment Engine to render accurate and reliable results. Podcasts may be used as an illustrative, non-limiting example to conceptualize the Public Sentiment Engine. In this illustrative example, every time, for instance, a podcaster mentions a particular term of interest (such as, for example, “elections”), that is—in effect—a vote for that term's relevance in the public debate. Accordingly, the Public Sentiment Engine may track the use of one or more such terms of interest over a set of (in this example) podcasts deemed to be of particular importance in the public discourse. Aggregated over hundreds or thousands of voices and perspectives, the methods and systems disclosed herein provide a way to systematically and reliably measure the public debate. The measure of sufficient size will depend upon how well the sample represents the population to which we are seeking to generalize. Any suitable number of podcasts may be indexed as desired for the particular implementation to draw conclusions regarding the public sentiment. In accordance with certain illustrative embodiments, somewhere in a range of approximately 1,000 to approximately 10,000 different podcasts may be indexed on a daily basis in order to provide a sufficient volume of data that can be used to draw meaningful results. As would be appreciated by those of ordinary skill in the art, having the benefit of this disclosure, podcasts are referenced as an illustrative, non-limiting example. Accordingly, the methods and systems disclosed herein can be used to draw conclusions regarding public sentiment using any desirable media such as, for example, TV broadcasts, radio broadcasts, social media postings, newspaper articles, etc. without departing from the scope of the present disclosure.

The content in the Aggregate Corpus 902 may be broken down into multiple subsets of data corresponding to a predetermined time period. For instance, in the illustrative embodiment of FIG. 9, the content of the Aggregate Corpus 902 is divided into subsets of data 902-1, 902-2, . . . , 902-N corresponding to different 24-hour periods. The data corresponding to each 24-hour period may be referred to as the “Daily Corpus.” As noted above, although a Daily Corpus is used as the unit for the Aggregate Corpus 902 in the illustrative embodiment of FIG. 9, the present disclosure is not limited as such. For instance, an hourly corpus, a weekly corpus, a monthly corpus, or any other desirable subset of data may be used by the Public Sentiment Engine without departing from the scope of the present disclosure.

At 904, the Aggregate Corpus 902 is analyzed using HAC in a manner similar to that discussed in conjunction with FIGS. 1a-c. Following the HAC analysis 904, at 906 the system uses the results of the HAC analysis to generate a ranked-order list of statistically significant terms (“Ranked Terms”) without any intervening human judgment. Next, at 908, each of the Ranked Terms is used to extract concept clusters and if applicable, sub-clusters, from the Aggregate Corpus 902. Specifically, each of the Ranked Terms is used to run a search on the Aggregate Corpus 902 to generate the corresponding concept clusters 910 for the Aggregate Corpus 902. In accordance with an illustrative embodiment of the present disclosure, the total number of documents within the extracted Concept Clusters 910 may be divided by the number of days for which data has been collected to derive a Baseline Term Prevalence for each of the Ranked Terms.

Similarly, the Ranked Terms may be used to extract concept clusters and if applicable, sub-clusters, from the Daily Corpus 902-13. Specifically, at 912, each Ranked Term may be used to extract concept clusters 914 from the daily corpus 902-13 for a given day. The total number of documents contained within each concept cluster 914A, 914B, 914C corresponding to a particular Ranked Term is the Daily Term Prevalence for that Ranked Term.

Once the concept clusters for the extracted Concept Clusters 910 and the Daily Corpus 914 have been generated, at 916 the two can be compared. Specifically, at 916, with respect to each Ranked Term, the Daily Term Prevalence may be compared with the Baseline Term Prevalence to identify any Ranked Term which has experience a large uptick in prevalence within the self-broadcasting community. The table below depicts an illustrative comparison for three hypothetical Ranked Terms relating to a hypothetical Aggregate Corpus and a hypothetical Daily Corpus. In this illustrative example, indicating a small uptick in the prevalence of the Ranked Term “Taxes,” a small decline in the prevalence of the Ranked term “Armed Forces” and a significant uptick in the prevalence of the Ranked Term “Education.”

| Ranked | Baseline Term | Daily Term | Percentage |
|---|---|---|---|
| Term | Prevalence | Prevalence | Variance |
| Taxes | 425 | 524 | +23% |
| Armed Forces | 74 | 54 | −27% |
| Education | 1033 | 4593 | +344% |

Finally, in accordance with certain illustrative embodiments, at step 920 all the Ranked Terms for a given daily corpus 902-13 may be ranked according to the deviation between their Baseline Term Prevalence and their Daily Term Prevalence.

In sum, the Public Sentiment Engine disclosed herein utilizes an Aggregate Corpus of self-broadcast content; converts each self-broadcast content into transcripts using natural language processing; indexes the transcripts and associated metadata; utilizes HAC to group the various transcripts into nested concept clusters; and analyzes the size and composition of the extracted clusters over time to identify and analyze trends in public sentiment.

The Public Sentiment Engine disclosed herein eliminates human bias from the design, implementation and interpretation of public sentiment research and enables continuous real-time detection of emerging trends in popular self-broadcasting platforms organically from unstructured data.

As would be appreciated by those of ordinary skill in the art, having the benefit of the present disclosure, although the Public Sentiment Engine disclosed herein is described in conjunction with analysis of content from self-broadcasters, it is not limited as such and can similarly be used in conjunction with other applications. For instance, the Public Sentiment Engine may likewise be used in any other context where it is desirable to analyze and/or evaluate large volumes of data on regular basis to determine hick topics are receiving unusually high “attention” or “chatter” (i.e., “Hot Topics”). For example, financial institutions that regularly record employee telephone calls may find it useful to know when there is an uptick in chatter about a particular topic. Moreover, the Public Sentiment Engine can be applied in instances where the Aggregate Corpus contains written data as opposed to spoken word data such as, for example, when it is desirable to analyze a large number of articles and/or editorials over a period of time to identify Hot Topics. In such an implementation, the methods and systems described in FIG. 9 remain unchanged except that the need to convert the spoken word data into searchable text is eliminated. A non-exhaustive list of applications where the Public Sentiment Engine disclosed herein proves beneficial includes, but is not limited to, applications involving corporate and government intelligence, legal electronic discovery, law enforcement, telemarketing, trading floor call records, and traditional media (e.g., Newspapers, News websites, radio stations, TV stations, etc.), public health, social psychology, measurement of public opinion, jury consulting, political campaigns, algorithmic trading, national security and military applications.

As would be appreciated, numerous other various combinations of the features discussed above can be employed without departing from the scope of the present disclosure. While the subject of this specification has been described in connection with one or more exemplary embodiments, it is not intended to limit any claims to the particular forms set forth. On the contrary, any claims directed to the present disclosure are intended to cover such alternatives, modifications and equivalents as may be included within their spirit and scope. Accordingly, all changes and modifications that come within the spirit of the disclosure are to be considered within the scope of the disclosure.

1. A system for reviewing, searching and analyzing raw data in a data corpus comprising:
a corpus optimization module, wherein the corpus optimization module converts the raw data to an optimized corpus;
a search composition module, wherein the search composition module operates on the optimized corpus to derive a set of search parameters;
a concept extraction module, wherein the concept extraction module performs a search on the optimized corpus using the set of search parameters derived by the search composition module and extracts a set of initial concept clusters;
a hybrid review module, wherein the hybrid review module receives the set of initial concept clusters from the concept extraction module and allows a user to review the optimized corpus using a user interface until the user declares the review complete; and
a visualization module, wherein the visualization module visualizes the results of the review, search and analysis of the raw data in the data corpus after the user declares the review complete.

2. The system of claim 1, wherein the corpus optimization module further comprises:
a connector framework,
wherein the connector framework is operable to controls access to the raw data by allowing a user to only access a subset of the raw data that is associated with the user's access group, and
wherein the connector framework converts the raw data into unstructured text; and
a chain of custody authentication module,
wherein the chain of custody authentication module keeps track of any changes to the raw data.

3. The system of claim 2, wherein the connector framework extracts information inherent in the raw data by performing at least one of natural language processing, voice finger printing, sentiment analysis, personality extraction, and persuasion metrics analysis.

4. The system of claim 2, wherein the chain of custody authentication module is a block chain tagging unit.

5. The system of claim 1, wherein the search composition module derives the search parameters based on at least one of user-provided search parameters, algorithmically derived search parameters from specified target files, and recursively derived search parameters based on operations of the concept extraction module.

6. The system of claim 1, wherein the raw data comprises at least one of written data and spoken word data.

7. The system of claim 1, wherein the raw data is loaded onto a cloud server.

8. The system of claim 1, wherein the set of search parameters comprises one or more of keywords, sender names, recipient names, key players, key issues and key dates.

9. The system of claim 1, wherein the concept extraction module uses Hierarchical Agglomerative Clustering (“HAC”) to extract the initial concept clusters.

10. The system of claim 1, further comprising an element assessment module, wherein the element assessment module contains a user supplied list of elements deemed to be relevant to a particular inquiry.

11. The system of claim 1, wherein the hybrid review module comprises a search mode and a review mode.

12. The system of claim 11, wherein in the review mode the information handling system is operable to:
receive the initial concept clusters from the concept extraction module,
allow the user to select one or more of the initial clusters as a cluster of interest;
apply a first relevancy boost to files in the optimized corpus that correspond to the cluster of interest;
display the files in the optimized corpus ranked in order of relevancy following the application of the first relevancy boost;
initiate an iterative looping process which is terminated when a desired Snyder Score is reached, wherein in the iterative looping process the information handling system is operable to:
allow the user to apply a relevancy designation to the files displayed;
apply a second relevancy boost to the files in the optimized corpus based on the relevancy designation applied by the user;
re-rank the files in the optimized corpus in order of relevancy following the application of the second relevancy boost;
update the Snyder Score in a Snyder Module; and
display the files in the optimized corpus ranked in order of relevancy following the application of the second relevancy boost.

13. The system of claim 1, wherein the user declares the review complete when a desired Snyder Score is reached.

14. The system of claim 11, wherein in the search mode the information handling system allows the user to execute a search query on the optimized corpus and apply a relevancy designation to results of the search query.

15. The system of claim 1, wherein the visualization module is operable to generate a report characterizing the data corpus.

16. A method of reviewing, searching and analyzing raw data in a data corpus comprising:
converting the raw data to an optimized corpus in a corpus optimization module;
deriving a set of search parameters in a search composition module, wherein the search parameters are derived by operating on the optimized corpus;
performing a search on the optimized corpus using the set of search parameters derived by the search composition module and extracting a set of initial concept clusters in a concept extraction module;
receiving the set of initial concept clusters from the concept extraction module in a hybrid review module and allowing a user to review the optimized corpus using a user interface until the user declares the review complete; and
visualizing the results of the review, search and analysis of the raw data in the data corpus after the user declares the review complete in a visualization module.

17. The method of claim 16, further comprising:
controlling access to the raw data by allowing a user to only access a subset of the raw data that is associated with the user's access group using a connector framework;
converting the raw data into unstructured text using the connector framework; and
keeping track of any changes to the raw data using a chain of custody authentication module.

18. The method of claim 17, wherein the chain of custody authentication module is a block chain tagging unit.

19. The system of claim 16, wherein deriving a set of search parameters in a search composition module comprises at least one of using user-provided search parameters, algorithmically deriving search parameters from specified target files, and recursively deriving search parameters based on operations of the concept extraction module.

20. The method of claim 16, wherein the raw data comprises at least one of written data and spoken word data.

21. The method of claim 16, wherein the raw data is loaded onto a cloud server.

22. The method of claim 16, wherein the set of search parameters comprises one or more of keywords, sender names, recipient names, key players, key issues and key dates.

23. The method of claim 16, wherein extracting a set of initial concept clusters in a concept extraction module comprises using Hierarchical Agglomerative Clustering (“HAC”) to extract the initial concept clusters.

24. The method of claim 16, wherein the hybrid review module comprises a search mode and a review mode.

25. The method of claim 24, wherein the review mode comprises:
receiving the initial concept clusters from the concept extraction module,
allowing the user to select one or more of the initial clusters as a cluster of interest;
applying a first relevancy boost to files in the optimized corpus that correspond to the cluster of interest;
displaying the files in the optimized corpus ranked in order of relevancy following the application of the first relevancy boost;
initiating an iterative looping process which is terminated when a desired Snyder Score is reached, wherein the iterative loop comprises:
allowing the user to apply a relevancy designation to the files displayed;
applying a second relevancy boost to the files in the optimized corpus based on the relevancy designation applied by the user;
re-ranking the files in the optimized corpus in order of relevancy following the application of the second relevancy boost;
updating the Snyder Score in a Snyder Module; and
displaying the files in the optimized corpus ranked in order of relevancy following the application of the second relevancy boost.

26. The method of claim 16, wherein the user declares the review complete when a desired Snyder Score is reached.

27. The method of claim 24, wherein the search mode comprises:
allowing the user to execute a search query on the optimized corpus; and
applying a relevancy designation to results of the search query.

28. The method of claim 16, wherein visualizing the results of the review further comprises generating a report characterizing the data corpus.

29. A computer readable medium having program code recorded thereon for execution on an information handling system for reviewing, searching and analyzing a data corpus, the program code causing the information handling system to perform the following method steps:
converting the raw data to an optimized corpus in a corpus optimization module;
deriving a set of search parameters in a search composition module, wherein the search parameters are derived by operating on the optimized corpus;
performing a search on the optimized corpus using the set of search parameters derived by the search composition module and extracting a set of initial concept clusters in a concept extraction module;
receiving the set of initial concept clusters from the concept extraction module in a hybrid review module and allowing a user to review the optimized corpus using a user interface until the user declares the review complete; and
visualizing the results of the review, search and analysis of the raw data in the data corpus after the user declares the review complete in a visualization module.
